(19) United States
(12) Patent Application Publication
(10) Pub. No.: US 2025/0264331 A1
(43) Pub. Date: Aug. 21, 2025

(54) MICROELECTROMECHANICAL INERTIAL SENSOR, AND METHOD FOR OPERATING A MICROELECTROMECHANICAL INERTIAL SENSOR

(71) Applicant: Robert Bosch GmbH, Stuttgart (DE)

(72) Inventors: Burkhard Kuhlmann, Reutlingen (DE); Thorsten Balslink, Kirchentellinsfurt (DE)

(21) Appl. No.: 19/020,017

(22) Filed: Jan. 14, 2025

(30) Foreign Application Priority Data
Feb. 21, 2024 (DE) 10 2024 201 573.3

(51) Int. Cl. G01C 19/5712

(52) U.S. Cl. CPC G01C 19/5712

(57) ABSTRACT

A microelectromechanical inertial sensor. The sensor includes: a first measuring component with oscillating elements, which outputs a first measuring signal and a second measuring signal according to a movement about an axis of rotation; and a second measuring component with oscillating elements, which outputs a third measuring signal and a fourth measuring signal according to a movement about the axis of rotation. An evaluation circuit generates a first difference signal of the first measuring signal and the second measuring signal and a second difference signal of the third measuring signal and the fourth measuring signal, amplifies the first difference signal, amplifies the second difference signal and generates an output signal based on a sum of the amplified first difference signal and the amplified second difference signal. The first difference signal and the second difference signal are in phase in the event of a first acceleration.

### CROSS REFERENCE

The present application claims the benefit under 35 U.S.C. § 119 of German Patent Application No. DE 10 2024 201 573.3 filed on Feb. 21, 2024, which is expressly incorporated herein by reference in its entirety.

### FIELD

The present invention relates to a microelectromechanical inertial sensor and to a method for operating a microelectromechanical inertial sensor.

### BACKGROUND INFORMATION

Microelectromechanical inertial sensors are used in various applications, for example in smartphones, game controllers, smart watches, drones or mobile devices.

In the automotive sector, inertial sensors, and in particular rotation rate sensors, are employed in vehicle dynamics control as well as in other applications like rollover sensing.

A key performance feature of inertial sensors is their robustness against external influences and in particular against vibrations caused by control interventions in systems or against external influences such as stone impacts or vibrating components in the interior or engine compartment.

Germany Patent Application No. DE 10 2020 205 372 A1 describes a microelectromechanical component for a rotation rate sensor and a corresponding production process.

### SUMMARY

The present invention provides a microelectromechanical inertial sensor and a method for operating a microelectromechanical inertial sensor.

Preferred example embodiments of the present invention are disclosed herein.

According to a first aspect, the present invention relates to a microelectromechanical inertial sensor. According to an example embodiment of the present invention, the microelectromechanical inertial sensor includes a first measuring component with oscillating elements, wherein the first measuring component outputs a first measuring signal and a second measuring signal according to a movement about an axis of rotation, and with a second measuring component with oscillating elements, wherein the second measuring component outputs a third measuring signal and a fourth measuring signal according to a movement about the axis of rotation. An evaluation circuit generates a first difference signal of the first measuring signal and the second measuring signal and a second difference signal of the third measuring signal and the fourth measuring signal, amplifies the first difference signal, amplifies the second difference signal and generates an output signal based on a sum of the amplified first difference signal and the amplified second difference signal. The first difference signal and the second difference signal are in phase in the event of a first acceleration. The evaluation circuit amplifies the first difference signal and the second difference signal in such a way that the output signal substantially disappears in the event of a second acceleration. The first acceleration is a Coriolis acceleration and the second acceleration is a rotational acceleration, or the first acceleration is a rotational acceleration and the second acceleration is a Coriolis acceleration.

According to a second aspect, the present invention relates to a method for operating a microelectromechanical inertial sensor that has a first measuring component with oscillating elements. According to an example embodiment of the present invention, the first measuring component outputs a first measuring signal and a second measuring signal according to a movement about an axis of rotation. A second measuring component with oscillating elements outputs a third measuring signal and a fourth measuring signal according to a movement about the axis of rotation. A first difference signal of the first measuring signal and the second measuring signal is generated, and a second difference signal of the third measuring signal and the fourth measuring signal is generated. The first difference signal and the second difference signal are in each case amplified. An output signal is generated based on a sum of the amplified first difference signal and the amplified second difference signal. The first difference signal and the second difference signal are in phase in the event of a first acceleration. The first difference signal and the second difference signal are amplified in such a way that the output signal substantially disappears in the event of a second acceleration. The first acceleration is a Coriolis acceleration and the second acceleration is a rotational acceleration, or the first acceleration is a rotational acceleration and the second acceleration is a Coriolis acceleration.

According to an example embodiment of the present invention, the micromechanical inertial sensor can be designed to measure Coriolis accelerations (rotation rates). Because two measuring components are provided, rotational accelerations can be suppressed. Conversely, with modified signal processing, the micromechanical inertial sensor can measure rotational accelerations, with Coriolis accelerations being suppressed.

By amplifying the signal after ascertaining the difference signal but prior to summing for determining the output signal, it is possible to suppress signals caused by rotational accelerations even if the two measuring components are not perfectly symmetrical.

Such an asymmetry can arise, for example, due to process inhomogeneities and is then stable over temperature or aging and can therefore be well compensated for by the amplification.

One cause of asymmetries can, for example, be an asymmetry in the spring width of springs of the first and the second measuring component. This asymmetry is not statistical, but rather, according to the position of the individual micromechanical inertial sensor on a wafer and the surrounding region through bond pads or bond frames, a gradient arises across the chip, which leads, for example, to the springs being of different widths. In simplified terms, this can be described by different natural frequencies of the measuring components. The weaker the measuring components are mechanically coupled to one another, the stronger this asymmetry is.

According to an example embodiment of the present invention, the microelectromechanical inertial sensor can in particular be provided in a three-axis rotation rate sensor, which is optimized with respect to robustness against rotational accelerations.

According to one example embodiment of the microelectromechanical inertial sensor of the present invention, the first measuring component has a first oscillating element and a second oscillating element. The second measuring component has a third oscillating element and a fourth oscillating element. The first oscillating element is arranged mirror-symmetrically to the third oscillating element with respect to a plane of symmetry. The second oscillating element is arranged mirror-symmetrically to the fourth oscillating element with respect to the plane of symmetry. In the event of a Coriolis acceleration, the first oscillating element and the fourth oscillating element are set into a first harmonic oscillating motion directed perpendicularly to the plane of symmetry. The second oscillating element and the third oscillating element are set into a second harmonic oscillating motion directed perpendicularly to the plane of symmetry. The first harmonic oscillating motion and the second harmonic oscillating motion are substantially out of phase with one another.

According to one example embodiment of the microelectromechanical inertial sensor of the present invention, in the event of a rotational acceleration the first oscillating element and the third oscillating element are set into a third harmonic oscillating motion directed perpendicularly to the plane of symmetry. The second oscillating element and the fourth oscillating element are set into a fourth harmonic oscillating motion directed perpendicularly to the plane of symmetry. The third harmonic oscillating motion and the fourth harmonic oscillating motion are substantially out of phase with one another.

According to one example embodiment of the microelectromechanical inertial sensor of the present invention, the first measuring signal is generated according to an oscillating motion of the first oscillating element. The second measuring signal is generated according to an oscillating motion of the second oscillating element. The third measuring signal is generated according to an oscillating motion of the third oscillating element. The fourth measuring signal is generated according to an oscillating motion of the fourth oscillating element.

According to one example embodiment of the present invention, the microelectromechanical inertial sensor has a microelectromechanical element (MEMS element), which comprises the first measuring component and the second measuring component. Furthermore, the microelectromechanical inertial sensor has an application-oriented integrated circuit (ASIC), which comprises the evaluation circuit. Thus, the summation for generating the output signal is not carried out on the MEMS element; rather, the measuring signals of the two measuring components are transmitted individually and the asymmetry can be compensated for individually in the ASIC (e.g., digitally).

According to one example embodiment of the microelectromechanical inertial sensor of the present invention, the evaluation circuit has a first digital amplifier stage, which is designed to amplify the first difference signal. The microelectromechanical inertial sensor has a second digital amplifier stage, which is designed to amplify the second difference signal. The amplification factors (gain factors) can be set to constant values. However, it is also possible to dynamically adapt the amplification factors based on other input parameters, e.g. on the basis of temperature sensor signals or stress sensor signals.

According to a further development of the present invention, the method for operating the microelectromechanical inertial sensor is carried out with an evaluation circuit of the microelectromechanical inertial sensor arranged on an ASIC.

According to a further development of the method of the present invention, the first difference signal is amplified with a first digital amplifier stage. The second difference signal is amplified by a second digital amplifier stage.

According to a further development of the method of the present invention, the microelectromechanical inertial sensor is subjected to a predefined Coriolis acceleration (or rotation rate). The resulting first amplified difference signal and the resulting second amplified difference signal are ascertained. Amplification factors for the first difference signal and the second difference signal are set based on a comparison of the first amplified difference signal and the second amplified difference signal. In particular, corresponding first and second analog or digital amplifier stages can be trimmed.

Further advantages, features and details of the present invention will become apparent from the following description, in which various exemplary embodiments are described in detail with reference to the figures.

### BRIEF DESCRIPTION OF THE DRAWINGS

FIG. 1 is a schematic block diagram of a microelectromechanical inertial sensor according to one example embodiment of the present invention in the event of a Coriolis acceleration.

FIG. 2 is a schematic block diagram of the microelectromechanical inertial sensor according to an example embodiment of the present invention in the event of a rotational acceleration.

FIG. 3 is a schematic representation of transfer functions.

FIG. 4 is a flow chart of a method for operating a microelectromechanical inertial sensor according to one example embodiment of the present invention.

In all figures, identical or functionally identical elements and devices are provided with the same reference signs. The numbering of method steps serves the purpose of clarity and is generally not intended to imply a specific chronological order. In particular, a plurality of method steps may also be carried out simultaneously.

### DETAILED DESCRIPTION OF EXAMPLE EMBODIMENTS

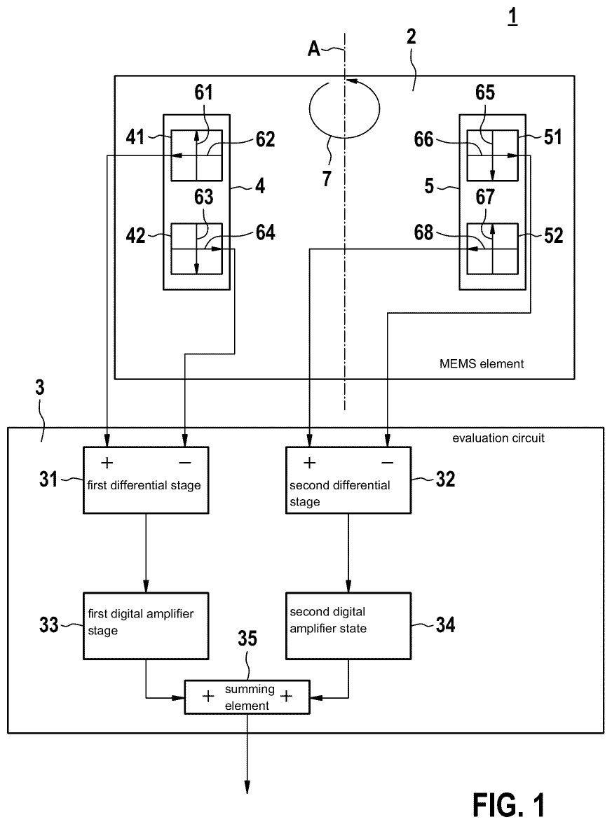

FIG. 1 is a schematic block diagram of a microelectromechanical inertial sensor 1 in the event of a Coriolis acceleration 7. The microelectromechanical inertial sensor 1 has a MEMS element 2, which comprises a first measuring component 4 and a second measuring component 5. Furthermore, the microelectromechanical inertial sensor has an ASIC, which represents or comprises an evaluation circuit 3.

The microelectromechanical inertial sensor 1 is designed to measure Coriolis accelerations 7 about an axis of rotation perpendicular to a substrate of the MEMS element 2.

The first measuring component 4 comprises a first measuring element 41 with a first oscillating element and a first drive structure and a second measuring element 42 with a second oscillating element and a second drive structure. The second measuring component 5 has a third measuring element 51 with a third oscillating element and a third drive structure and a fourth measuring element 52 with a fourth oscillating element and a fourth drive structure. The first measuring element 41 is arranged mirror-symmetrically to the third measuring element 51 with respect to a plane of symmetry A. The second measuring element 42 is arranged mirror-symmetrically to the fourth measuring element 52 with respect to the plane of symmetry A.

The first to fourth drive structures are deflected parallel to the plane of symmetry A by a drive signal (for example, by applying an electrical voltage). For this purpose, the first and fourth drive structures are set into an in-phase harmonic oscillating motion 61 or 67, and the second and third drive structures are set into a harmonic oscillating motion 63 or 65 that is out of phase with the others (i.e., shifted by) 180°. The structure of the microelectromechanical inertial sensor 1 can substantially correspond to the sensor described in German Patent Application No. DE 10 2020 205 372 A1.

In the event of a Coriolis acceleration 7, the first oscillating element and the fourth oscillating element are set into a first harmonic oscillating motion 62 or 68 directed perpendicularly to the plane of symmetry. The second oscillating element and the third oscillating element are set into a second harmonic oscillating motion 64 or 66 directed perpendicularly to the plane of symmetry. The first harmonic oscillating motion 62, 68 and the second harmonic oscillating motion 64, 66 are substantially out of phase (contradirectional), i.e. offset by 180° from one another.

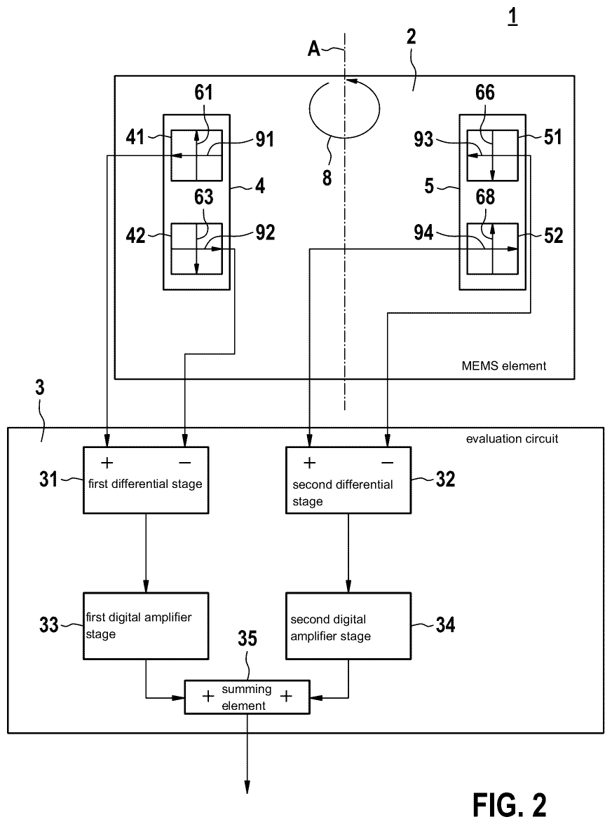

As shown in FIG. 2, in the event of a rotational acceleration, the first oscillating element and the third oscillating element are set into a third harmonic oscillating motion 91 or 93 directed perpendicularly to the plane of symmetry. The second oscillating element and the fourth oscillating element are set into a fourth harmonic oscillating motion 92 or 94 directed perpendicularly to the plane of symmetry. The third harmonic oscillating motion 91, 93 and the fourth harmonic oscillating motion 92, 94 are substantially out of phase with one another.

The first measuring component 4 outputs a first measuring signal and a second measuring signal according to a movement about the axis of rotation. The second measuring component 5 outputs a third measuring signal and a fourth measuring signal according to a movement about the axis of rotation. The first measuring signal is generated according to an oscillating motion of the first oscillating element. The second measuring signal is generated according to an oscillating motion of the second oscillating element. The third measuring signal is generated according to an oscillating motion of the third oscillating element. The fourth measuring signal is generated according to an oscillating motion of the fourth oscillating element.

The evaluation circuit 3 comprises a first differential stage 31, which generates a first differential signal of the first measuring signal and the second measuring signal. The evaluation circuit 3 further comprises a second differential stage 32, which generates a second differential signal of the third measuring signal and the fourth measuring signal.

The evaluation circuit 3 has a first digital amplifier stage 33, which amplifies the first difference signal. The evaluation circuit 3 further has a second digital amplifier stage 34, which amplifies the second difference signal.

Furthermore, the evaluation circuit 3 comprises a summing element 35, which adds the amplified first difference signal and the amplified second difference signal and thereby generates an output signal. The first difference signal and the second difference signal are in phase in the event of Coriolis accelerations. The evaluation circuit amplifies the first difference signal and the second difference signal in such a way that the output signal substantially disappears in the event of rotational accelerations. This will be explained in more detail below.

The first to fourth measuring signals are generated based on capacitance values at measuring electrodes.

Let CP_{z1} designate the capacity at the first measurement element and dC_{cor,1} the change in capacity due to the Coriolis acceleration a_{cor} for the first measurement component 4. Then, the first measuring signal is given by

$${CP}_{z 1} + {dC}_{cor , 1} = {CP}_{z 1} + {a}_{cor} \cdot {H}_{z 1} ,$$

where H_{z1} designates the frequency-dependent transfer function of the detection and comprises not only the mechanical transfer function but also the capacitive sensitivity of the detection electrodes, i.e. dC/dx.

The transfer function is given by:

$${H}_{z 1} = \frac{\partial C}{\partial x} \cdot \frac{1}{{( 2 π {f}_{1} )}^{2}} \cdot \frac{1}{( 1 - \frac{{f}^{2}}{{f}_{1}^{2}} ) + i \cdot \frac{f}{{Q}_{1} \cdot {f}_{1}}}$$

f₁ describes the natural frequency of the first measuring element, Q₁ designates the quality of the first measuring element and f the stimulating frequency.

Analogously, CN_{z1}, CP_{z2} and CN_{z2} designate the capacitance at the second to fourth measuring elements and dC_{cor,2} the capacitance change due to the Coriolis acceleration a_{cor} for the second measuring component 5.

Then, the second measuring signal is given by

$${CN}_{z 1} + {dC}_{cor , 1} = {CN}_{z 1} + {a}_{cor} \cdot {H}_{z 1} .$$

The third measuring signal is given by

$${CN}_{z 2} + {dC}_{cor , 2} = {CN}_{z 2} + {a}_{cor} \cdot {H}_{z 2} .$$

The fourth measuring signal is given by

$${CP}_{z 2} + {dC}_{cor , 2} = {CP}_{z 2} + {a}_{cor} \cdot {H}_{z 2} .$$

The first difference signal is then proportional to

a_{cor}·H_{z1}.

The second difference signal is proportional to

a_{cor}·H_{z2}.

They DigGain₁ and DigGain₂ now designate the amplifications (gain) of the first amplifier stage 33 or the second amplifier stage 34. The output signal of the summing element 35 is then proportional to:

$${a}_{cor} \cdot ( {H}_{z 1} \cdot {DigGain}_{1} + {H}_{z 2} \cdot {DigGain}_{2} ) .$$

In the event of a rotational acceleration aₜᵤᵣₙ, the first measuring signal is given by:

$${CP}_{z 1} + {a}_{turn} \cdot {H}_{z 1} .$$

The second measuring signal is given by:

$${CN}_{z 1} - {a}_{turn} \cdot {H}_{z 1} .$$

The third measuring signal is given by:

$${CN}_{z 2} + {a}_{turn} \cdot {H}_{z 2} .$$

The fourth measuring signal is given by:

$${CP}_{z 2} - {a}_{turn} \cdot {H}_{z 2} .$$

The output signal of the summing element 35 is then proportional to:

$${a}_{turn} \cdot ( {H}_{z 1} \cdot {DigGain}_{1} - {H}_{z 2} \cdot {DigGain}_{2} ) .$$

In the symmetric case

H_{z1}=H_{z2}

the signal generated by rotational acceleration is perfectly suppressed even without amplification. In the event of asymmetries

H_{z1}≠H_{z2}

however, this would degrade the performance, which could not be compensated for by a later correction without amplification prior to the addition of the signals.

Regarding the susceptibility of a rotation rate sensor, the frequency range around the drive frequency is particularly relevant. This range results from the output bandwidth of the microelectromechanical inertial sensor 1, typically 80 to 500 Hz. The drive frequency is typically 10 to 50 kHz, for example 35 kHz.

The microelectromechanical inertial sensor 1 can be operated partially resonantly, i.e. the resonance frequency of the oscillating elements is above or below the drive frequency with a distance of typically 1000 to 5000 Hz, for example −3000 Hz. There may now be an asymmetry between the two measuring components 4, 5, for example of 100 Hz.

By transmitting the signals separately, the error caused by rotational accelerations can be reduced by specifically trimming DigGain₁/DigGain₂ in accordance with:

$${H}_{z 1} \cdot {DigGain}_{1} = {H}_{z 2} \cdot {DigGain}_{2}$$

Both the Coriolis acceleration and the critical rotational accelerations act at the drive frequency f. It is now possible to determine DigGain₁ and DigGain₂ (for example, with a standard adjustment of the rotation rate sensitivity), since the output signal also has exactly this transfer function as an amplification in the event of a Coriolis acceleration. For this purpose, the microelectromechanical inertial sensor 1 can be rotated and both rotation rate channels can be evaluated prior to adding the final output signal. Thus, at each applied rotation rate

2·a_{cor}·H_{z1}·DigGain₁

and

2·a_{cor}·H_{z2}·DigGain₂

are determined.

If both rotation rate channels are trimmed to the same sensitivity, rotational accelerations are suppressed as best as possible.

If gain differences do not result from mechanics but from electrostatics, these can also be corrected via individual gain adjustment.

With modified signal processing, it can be provided that the micromechanical inertial sensor 1 measures rotational accelerations, with Coriolis accelerations being suppressed. For this purpose, a differential stage can be used instead of the summing element 35, which differential stage subtracts the signals.

According to further embodiments, it can also be provided that the relative sign in the component 35 can be changed. For example, in the event of a dynamic change, both measured quantities (rotational acceleration and Coriolis acceleration) can be separated and measured separately, while the other quantity is in each case suppressed.

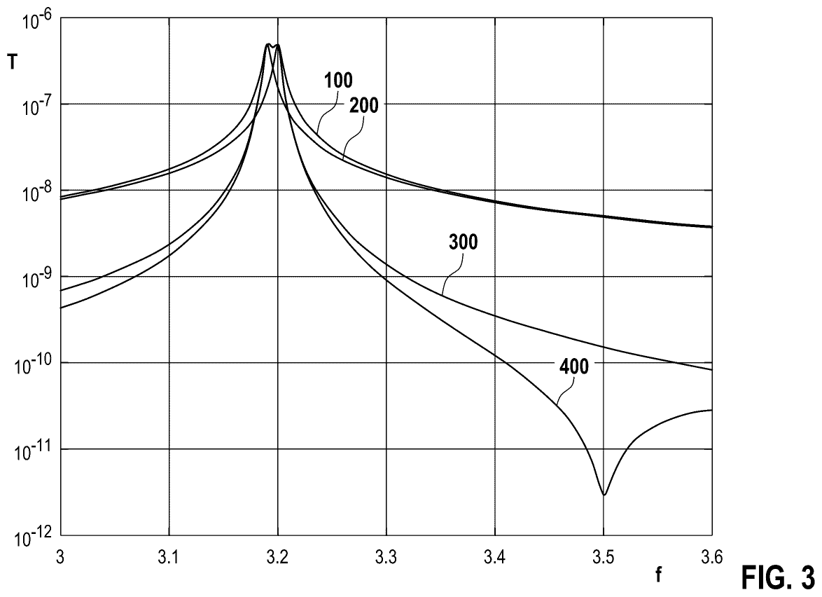

FIG. 3 is a schematic representation of exemplary progressions of transfer functions. Shown are a progression 100 of H_{z1}, a progression 200 of H_{z2}, a progression 300 of H_{z1}−H−_{z2} without correction, i.e. without amplification, and a progression 400 of H_{z1}−H−_{z2} with correction.

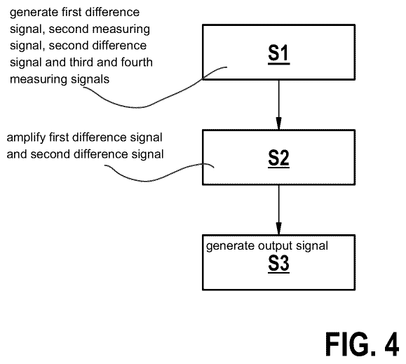

FIG. 4 is a flow chart of a method for operating a microelectromechanical inertial sensor, in particular the microelectromechanical inertial sensor 1 described above.

The microelectromechanical inertial sensor 1 has a first measuring component 4 with oscillating elements. The first measuring component outputs a first measuring signal and a second measuring signal according to a movement about an axis of rotation.

A second measuring component 5 with oscillating elements outputs a third measuring signal and a fourth measuring signal according to a movement about the axis of rotation.

In a first step S1, a first difference signal of the first measuring signal and the second measuring signal is generated. Furthermore, a second difference signal of the third measuring signal and the fourth measuring signal is generated.

In a second step S2, the first difference signal and the second difference signal are in each case amplified.

In a step S3, an output signal is generated based on a sum of the amplified first difference signal and the amplified second difference signal.

The first difference signal and the second difference signal are in phase in the event of Coriolis accelerations. The first difference signal and the second difference signal are amplified in such a way that the output signal substantially disappears in the event of rotational accelerations.

The described method for operating the microelectromechanical inertial sensor 1 can be carried out with an evaluation circuit 3 of the microelectromechanical inertial sensor 1 arranged on an ASIC.

The first difference signal can be amplified with a first digital amplifier stage 33. The second difference signal is then amplified with a second digital amplifier stage 34.

For determining the amplification factors of the amplifier stages 33, 34, the microelectromechanical inertial sensor 1 can be subjected to a predefined Coriolis acceleration. The resulting first amplified difference signal and the resulting second amplified difference signal are ascertained. The amplification factors for the first difference signal and the second difference signal are set based on a comparison of the 10 first amplified difference signal and the second amplified difference signal. In particular, the first and second amplifier stages can be trimmed.

What is claimed is:

1. A microelectromechanical inertial sensor, comprising:
a first measuring component with oscillating elements, wherein the first measuring component is configured to output a first measuring signal and a second measuring signal according to a movement about an axis of rotation;
a second measuring component with oscillating elements, wherein the second measuring component is configured to output a third measuring signal and a fourth measuring signal according to a movement about the axis of rotation; and
an evaluation circuit configured to generate a first difference signal of the first measuring signal and the second measuring signal and to generate a second difference signal of the third measuring signal and the fourth measuring signal, to amplify the first difference signal and the second difference signal, and to generate an output signal based on a sum of the amplified first difference signal and the amplified second difference signal;
wherein the first difference signal and the second difference signal are in phase in an event of a first acceleration, and wherein the evaluation circuit is configured to amplify the first difference signal and the second difference signal in such a way that the output signal substantially disappears in the event of a second acceleration;
wherein: (i) the first acceleration is a Coriolis acceleration and the second acceleration is a rotational acceleration, or (ii) the first acceleration is a rotational acceleration and the second acceleration is a Coriolis acceleration.

2. The microelectromechanical inertial sensor according to claim 1, wherein the first measuring component has a first oscillating element and a second oscillating element, and wherein the second measuring component has a third oscillating element and a fourth oscillating element, wherein the first oscillating element is arranged mirror-symmetrically to the third oscillating element with respect to a plane of symmetry, and wherein the second oscillating element is arranged mirror-symmetrically to the fourth oscillating element with respect to the plane of symmetry, wherein in the event of a Coriolis acceleration, the first oscillating element and the fourth oscillating element are set into a first harmonic oscillating motion directed perpendicularly to the plane of symmetry and the second oscillating element and the third oscillating element are set into a second harmonic oscillating motion directed perpendicularly to the plane of symmetry, wherein the first harmonic oscillating motion and the second harmonic oscillating motion are substantially out of phase with one another.

3. The microelectromechanical inertial sensor according to claim 2, wherein in the event of a rotational acceleration, the first oscillating element and the third oscillating element are set into a third harmonic oscillating motion directed perpendicularly to the plane of symmetry, and the second oscillating element and the fourth oscillating element are set into a fourth harmonic oscillating motion directed perpendicularly to the plane of symmetry, wherein the third harmonic oscillating motion and the fourth harmonic oscillating motion are substantially out of phase with one another.

4. The microelectromechanical inertial sensor according to claim 3, wherein the first measuring signal is generated according to an oscillating motion of the first oscillating element, wherein the second measuring signal is generated according to an oscillating motion of the second oscillating element, wherein the third measuring signal is generated according to an oscillating motion of the third oscillating element, and wherein the fourth measuring signal is generated according to an oscillating motion of the fourth oscillating element.

5. The microelectromechanical inertial sensor according to claim 1, further comprising:
a microelectromechanical element, which includes the first measuring component and the second measuring component; and
an application-oriented integrated circuit, which includes the evaluation circuit.

6. The microelectromechanical inertial sensor according to claim 1, wherein the evaluation circuit has a first digital amplifier stage, which is configured to amplify the first difference signal, and a second digital amplifier stage, which is configured to amplify the second difference signal.

7. A method for operating a microelectromechanical inertial sensor, which includes a first measuring component with oscillating elements, wherein the first measuring component outputs a first measuring signal and a second measuring signal according to a movement about an axis of rotation, and which includes a second measuring component with oscillating elements, wherein the second measuring component outputs a third measuring signal and a fourth measuring signal according to a movement about the axis of rotation, the method comprising the following steps:
a) generating a first difference signal of the first measuring signal and the second measuring signal, and a second difference signal of the third measuring signal and the fourth measuring signal;
b) amplifying the first difference signal and the second difference signal; and
c) generating an output signal based on a sum of the amplified first difference signal and the amplified second difference signal;
wherein the first difference signal and the second difference signal are in phase in an event of a first acceleration, and wherein the first difference signal and the second difference signal are amplified in such a way that the output signal substantially disappears in the event of a second acceleration;
wherein; (i) the first acceleration is a Coriolis acceleration and the second acceleration is a rotational acceleration, or (ii) the first acceleration is a rotational acceleration and the second acceleration is a Coriolis acceleration.

8. The method according to claim 7, wherein steps a) to c) are carried out using an evaluation circuit of the microelectromechanical inertial sensor arranged on an application-oriented integrated circuit.

9. The method according to claim 7, further comprising the following steps:
subjecting the microelectromechanical inertial sensor to a predefined Coriolis acceleration;
ascertaining a resulting first amplified difference signal and a resulting second amplified difference signal; and
setting amplification factors for the first difference signal and the second difference signal based on a comparison of the first amplified difference signal and the second amplified difference signal.

10. The method according to claim 7, wherein the first difference signal is amplified with a first digital amplifier stage, and wherein the second difference signal is amplified with a second digital amplifier stage.
